(19) United States
(12) Patent Application Publication
(10) Pub. No.: US 2004/0119238 A1
(43) Pub. Date: Jun. 24, 2004

(54) Labyrinth seal between rotating parts

(76) Inventors: Erwin Skumawitz, Sch?ouml;nheide (DE); Dieter Hallmann, Berlin (DE)

Correspondence Address: HOWREY SIMON ARNOLD & WHITE, CITYPOINT, ONE ROPEMAKER STREET, LONDON, EC2Y 9HS, GB

(21) Appl. No.: 10/220,841

(22) PCT Filed: Feb. 26, 2001
(86) PCT No.: PCT/EP01/02152

(30) Foreign Application Priority Data
Mar. 7, 2000 (DE) 100 11 063.0

(51) Int. Cl. F16J 15/447

(52) U.S. Cl. 277/412

(57) ABSTRACT

In order to reduce or prevent axial leakage flow during operation of a labyrinth seal by means of a sealing ring gap 12, said sealing ring gap 12 is designed so as to be conical, with the diameter increasing towards the direction of the leakage flow.

The invention relates to a labyrinth seal according to the precharacterising part of claim 1.

A labyrinth seal of this type, known from DE 44 03 776 A1, has been applied in the region of a ball bearing, at the transition between a drive motor and a gear arrangement flange-mounted to said drive motor. In this arrangement, a component which is fixed to the housing, comprises ring elements which are directed radially inward, and are arranged parallel to each other, with the inside diameter of all ring elements being the same. A further ring-shaped component is located on the rotor shaft of the drive motor, said further ring-shaped component in the region of the front faces of the individual ring elements, comprising adjacent cylindrical sealing faces. In addition, this further component comprises radially outward-directed throw-off webs which grip between ring elements. The diameter of the front faces of the ring elements is slightly larger than the diameter of the associated cylindrical sealing face, so that an encompassing narrow sealing ring gap, in the shape of a hollow cylinder, forms between the respective front face and the associated sealing face. The front face and the sealing face thus for the inner and the outer surface area of the respectively associated sealing ring gap. Practical application has shown that it is impossible to achieve complete concentric running of the sealing faces. Due to such errors in shape and position which are technically unavoidable, the width of the sealing ring gap, which gap is very small anyway, changes dynamically with the frequency of rotation. Thus, if for example oil, either in droplet form or as oil foam, flows from the ball bearing into the labyrinth seal and thus into the sealing ring gap, then the eccentrically rotating sealing face acts in the manner of a pump, thus conveying the contamination through the sealing ring gap, where it can reach the motor and cause malfunctions. In order to prevent this deficiency, a relief region is integrated into the labyrinth arrangement, said relief region being connected, via a channel, to a diffuser which acts as a venturi nozzle, said diffuser communicating with the outside atmosphere.

It is the object of the invention, in a labyrinth seal, to provide measures which counteract the pumping action.

According to the invention, this object is met by the measure stated in the characterizing part of claim 1.

In a design of a labyrinth seal according to the invention, due to the conical shape of the sealing ring gap in relation to the axial pumping action which results from the already mentioned dynamic changes of the sealing ring gap due to an out-of round state, in addition, a radial component is generated in the sealing ring gap. This radial component of the pumping action depends on the rotational speed, the diameter and the radial expansion as well as the inclination of the conical sealing ring gap in axial direction. Preferably, the radial width of the gap remains the same along the axial extension. This results in a sealing ring gap in the shape of a truncated hollow cone. However, it is also possible to conically incline only one of the surface areas of the sealing ring gap, that is to say either the front face of the ring element or the sealing face, at the associated further component. It is also possible for both the aforementioned surface areas to be inclined in opposite direction in relation to axial direction. It can also be suitable if the inclination of the aforementioned surface areas extends only along part of their axial extension. In particular the inclination of the outer surface area of the sealing ring gap determines the extent of the pumping action. The pumping action is directed towards that end of the sealing ring gap with the larger diameter. The larger diameter of the sealing ring gap is thus arranged on the side from which interfering fluids, in particular oil, water or the like, can flow towards the labyrinth seal. As far as the pumping action is concerned, the radial centrifugal force which acts in this process on the fluid to be retained, can be of importance, with said centrifugal force conveying fluid which has entered the sealing ring gap, outwards. A flow component then occurs on the inclined outer surface area; with said flow component acting against the fluid flowing in as a result of axial pumping action generated by out-of round running. The magnitude of the counter-acting force component can be set by selecting the inclination of the cone and the rotational speed. In order to be able to keep the diameter of the component comprising the sealing faces as small as possible, there are axially sequential sealing faces in the shape of truncated cones, which when seen in longitudinal section, are mutually arranged in a sawtooth-like manner, so that the average diameter can at least approximately be the same. It is also possible to design the labyrinth seal with sealing ring gaps which are inclined in opposite directions. In this way it is then possible for example, from a ventilated section of the labyrinth seal located in the central axial region, to counteract the ingress of fluids from the direction of both end regions. Apart from this, a common sealing face can also be associated to several opposing ring surfaces. Furthermore, it is advantageous to provide radially outward directed throw-off rings, at least between some adjacent sealing faces. These throw-off rings reach between associated adjacent ring elements, radially throwing off fluids that have penetrated the sealing ring gap, into the collecting grooves provided between the associated ring elements. The fluid thrown off can be led away by a mutual collection channel.

Below, the invention is explained in more detail with reference to an embodiment of a labyrinth seal shown in the drawing.

The following are shown:

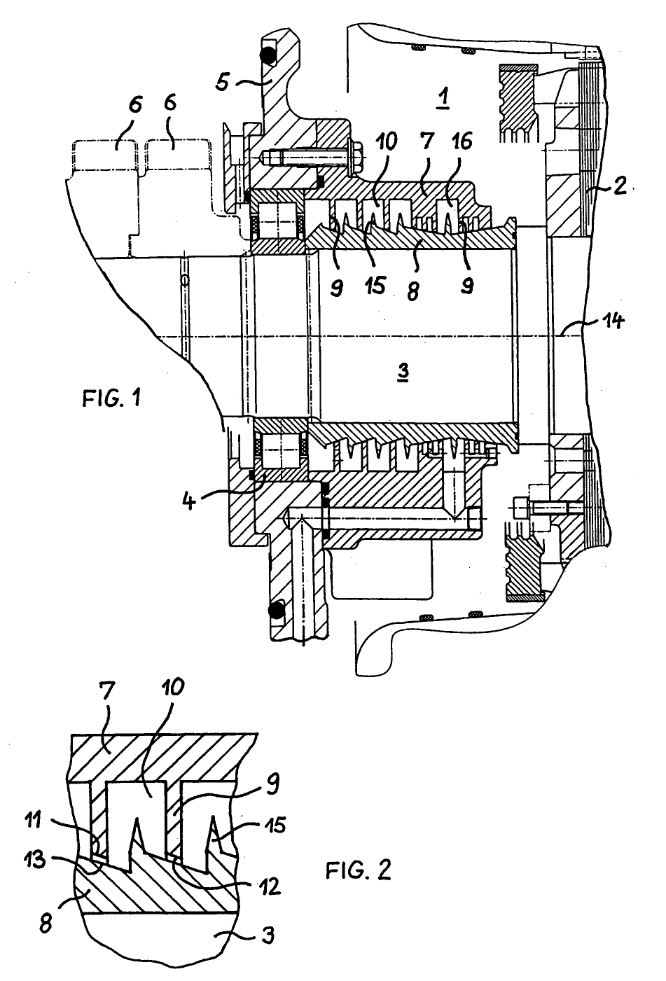

FIG. 1 a longitudinal section of a labyrinth seal affixed to the end shield of a motor; and

FIG. 2 an enlarged view of the ring seal in the region of a sealing ring gap.

According to FIG. 1, a rotor 2 in attached to a shaft 3 in the interior 1 of a stationary housing of an electric motor. By way of a roller bearing 4, the shaft 3 is rotatably held in an end shield 5 of the housing. The end of the shaft 3 protruding from the interior space 1 of the housing towards the exterior, establishes a drive connection with a mechanical gear arrangement directly connected to the end shield 5, of which gear arrangement only an arrangement of gearwheels 6 is shown. The gearwheels 6 run in an oil bath (not shown). The quantity of oil conveyed by the Sear wheels 6 also serves to lubricate the roller bearing 4. In order to prevent gear oil which axially passes through the roller bearing 4 from reaching the interior apace 1 of the motor housing, a multi-chamber labyrinth seal which extends in axial direction to the rotor 2, is arranged axially adjacent to the roller bearing 4. The labyrinth seal comprises a sleeve-shaped interior component 8, which is attached to the shaft 3 and rotates with said shaft 3, and an exterior component 7 which encompasses the interior component, 8 in the manner of a shell, said exterior component, 7 being firmly connected to the end shield 5. At the interior wall of the exterior component 7 there are radially inward directed ring elements 9 which are arranged so as to be axially spaced apart from each other, with hollow spaces 10 of U-shaped cross section being arranged between said ring elements 9. A shown in FIG. 2, each of the radially inward pointing front faces 11 of the ring elements 9 is closely adjacent to and, without touching it, faces a sealing face 13 so as to form a sealing ring gap 12, said sealing face being formed at the exterior wall of the sleeve-shaped component 8 which rotates together with the shaft 3. Since in practical operational conditions the sealing face 13 does not run entirely concentrically, the radial width of the sealing ring gap 12 changes with the rotational frequency of the shaft 3. In the sealing ring gap 12 this causes, for example, lubricant emanating from the roller bearing 4 to be pumped through the sealing ring gap 12, in spite of the very small gap width.

In order to prevent any undesirable throughput of fluid through the sealing ring gap 12, said sealing ring gap 12 is conical. To this effect, in the present embodiment, both the front face 11 at the ring element 9 and the associated sealing face 13 are conical in shape. In the embodiment shown, the inclination at the front face 11 and the sealing face 13 is the same in relation to the indicated axis 14 of the shaft 3; with said inclination also being in the same direction. Thus the sealing ring gap 12 is in the shape of a truncated hollow cone whose diameter expands towards the direction from which the fluid to be retained (in the present example lubricating oil) creeps in. With the shaft 3 rotating and the sealing face 13 rotating with it, any fluid which approaches the sealing ring gap 12 is accelerated radially outward when it reaches the sealing ring gap 12. At the associated inclined front face 11 said fluid is subjected to deflection with a force component exerted against the directions of inflow of the fluid. By selecting the inclination, taking into account the rotational speed of the shaft 3, the force component can be selected such that the pumping action, generated by out-of round running in the sealing ring gap 12, is counteracted, with said pumping action being at least partly compensated for. By providing several multiples of a labyrinth gap seal designed in this way, the fluid throughput through a labyrinth seal designed accordingly can be reduced at least to such an extent that no additional measures are necessary or respectively, only a reduced number of sealing ring gaps 12, each being formed by ring element 9 and sealing face 13, are necessary to achieve the same sealing effect, when compared to arrangements comprising purely cylindrical sealing ring gaps.

Unlike the design n the embodiment shown, where the conical surface areas 11 and 13 of the sealing ring gap 12 have the same inclination, it can also suffice if only the front face 11 or the sealing surface 13 is of conical design. However, the direction of the resulting force component in relation to the desired improved sealing relationship will have to be taken into account.

In order to keep the radial wall thickness of the interior component 8 as small as possible, the average diameter of at least two adjacent conical sealing ring gaps 12 is selected so as to be at least approximately the same size. In this arrangement, the associated truncated-cone shaped sealing faces 13, which are provided so as to be side by side on the rotatably held component 8, form a sawtooth shape edge in axial longitudinal section.

In order to improve the throw-off of fluid which has nevertheless penetrated the sealing ring gap 12, throw-off rings 15, which are directed radially outward, are provided in the region of the sawtooth tips, between the adjacent sealing faces 13, said throw-off rings 15 protruding between associated adjacent ring elements 9.

Where there is a possibility of undesirable fluids penetrating from both sides of the seal, it is advantageous to provide sealing ring gaps 12 inclined in opposite directions in axial end regions of the labyrinth seal. Accordingly, in the embodiment shown, the end section of the interior component 8, which end section faces the rotor 2, comprises a sealing face 13 which is inclined in relation to the axis 14 in opposite direction to the inclination of the sealing face 13 at the opposite end of the labyrinth seal, which end faces the gear arrangement. Accordingly, the front faces 11 of the associated ring elements 9 are also inclined in opposite direction. In the present example, a neutral chamber 16 is inserted in the labyrinth seal between the regions in which the stealing ring gap 12 is inclined in opposite directions. Fluid which has entered is led from said chamber, to the exterior. In contrast, from the hollow spaces 10 which face the gear arrangement, the fluid which has been deposited therein (namely gear oil in the present embodiment) can be returned to the roller bearing 4 or to the gear arrangement.

Furthermore, it is also possible to allocate at least two ring elements 9 to a common sealing face 13 as shown in the embodiment according to FIG. 1, on both aides of the neutral chamber 16.

Altogether, an improvement in the sealing effect without the need for additional space or other resources is achieved as a result of the conical design of the sealing ring gap 12. On the other hand, as a result of the force component which can be utilised in this way, the requirements for throttle action of the sealing ring gap 12 can be reduced, i.e. the radial gap width can be increased so that production of components can be carried out at reduced precision. With an increased width in the gap, its relative dynamic change is also reduced when the shaft 3 rotates, which again brings about a reduction in the undesirable pumping effect as far as oil from the opposite direction is concerned. Despite a conical design of the sealing face 13, the diameter of the interior component 8 need not be enlarged, if the sealing faces 13, seen in longitudinal section view, axially adjoin each other in a sawtooth-like manner. For ease of installation, the exterior component 7 together with the ring elements 9 is made in divided parts while the interior component 8 with the sealing faces 13 and the throw-off rings 15 forms a single-part unit. Both components 7 and 8 are rotatable in relation to each other, but they are axially fixed except for same displacement that is normal during operation. Furthermore, that part of the respective sealing face 13 which is directly associated with a front face 11 is designed without any interruption in axial direction.

1. A labyrinth seal between components (7, 8) which are rotatable on an axis (14) in relation to each other and which are axially fixed, comprising at least two ring-shaped uninterrupted sealing ring gaps (12) arranged axially one behind the other, arranged between a front face (11) of a ring element (9) arranged on a component (7) and an opposing sealing face (13) which is directly adjacent without touching, on the other component (8), wherein the front face (11) and the sealing face (13) form the surface areas of the associated sealing ring gap (12), characterized in that at least one surface area (11, 13) of at least one sealing ring gap (12) is of conical design.

2. The labyrinth seal according to claim 1, characterized in that one front face (11) is of conical design.

3. The labyrinth seal according to claim 1 or 2, characterized in that one sealing face (13) is of conical design.

4. The labyrinth seal according to at least one of claims 1 to 3, characterised in that both surface areas (11, 13) of a sealing ring gap (12) are of conical design and have the same inclination.

5. The labyrinth seal according to at least one of claims 1 to 4, characterized in that the average diameter of at least two adjacently arranged conical sealing ring gaps (12) is approximately the same.

6. The labyrinth seal according to at least one of claims 1 to 5, characterised in that sealing ring gaps (12) which are inclined in opposite directions are provided.

7. The labyrinth seal according to at least one of claims 1 to 6, characterised in that at least two ring elements (9) face a continuous mutual sealing face (13).

8. The labyrinth seal according to at least one of claims 1 to 7, characterised in that several conical sealing faces (13) are arranged axially one behind the other on a component (8).

9. The labyrinth seal according to claim 8, characterised in that throw-off rings (15), which are radially outward directed, are arranged between adjacent sealing faces (13), with said throw-off rings (15) protruding between associated adjacent ring elements (9).
